(19) United States
(12) Patent Application Publication
(10) Pub. No.: US 2007/0160967 A1
(43) Pub. Date: Jul. 12, 2007

(54) Apparatus and methods for mounting a specimen in a solid material

(76) Inventor: John A. Halley, Stillwater, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/603,791

(22) Filed: Nov. 21, 2006

Related U.S. Application Data
(60) Provisional application No. 60/739,457, filed on Nov. 23, 2005.

(51) Int. Cl. G09B 23/00; G01N 1/28; A01N 3/00

(52) U.S. Cl. 434/296; 427/2.11; 427/4; 434/297

(57) ABSTRACT

This invention relates to an apparatus and methods for mounting specimens in a plastic or other solid casting material so that the mounted specimen may be examined and tested. The apparatus forms a flat window in the specimen casting or facilitates the formation of a flat window. The specimen may be examined through the flat window.

### CROSS REFERENCE TO RELATED APPLICATIONS

This present utility patent application claims the priority and benefits of U.S. Provisional Application 60/739,457 filed Nov. 23, 2005, which is hereby incorporated in its entirety herein by reference.

### BACKGROUND OF THE INVENTION

1. Field of the Invention

The present inventions relate to molds and, more particularly, to apparatus and methods for mounting specimens for examination and testing.

2. Description of the Related Art

Specimens in a number of fields may be mounted in solid casting material for examination and/or testing. The casting material is typically poured over a specimen positioned in a mold. After the casting material has cured or set, the specimen casting is removed from the mold. The specimen casting may then be processed further to enable examination or testing of the encased specimen.

Commonly mounted specimens could include biological tissues, petrographic specimens, metallographic specimens, composite materials, electrical components and devices, among others. Mounting can preserve certain types of specimens and enable manipulation of the specimen for examination. Mounting may also permit the sectioning or sequential sectioning of the mounted specimen. Small or oddly shapes specimens may be more easily handled when mounted, and fragile or friable specimens may be preserved by mounting. Porous specimens may be infiltrated with low viscosity resin. Specimens that are sensitive to heat or pressure may be mounted by immersion in a casting material in an open specimen mold.

In many applications, the casting material with the specimen is cast in a cylindrical mold to form a specimen casting. Then, in order to analyze the specimen within the specimen casting, a flattened region may be formed on the side of the cylindrical specimen casting. The flattened region forms a flat window in the specimen casting through which the specimen may be analyzed. This flat window is normally formed by abrading the circular side of the specimen casting through a series of successive grinding and polishing operations. This may be accomplished by a technician pushing the rounded side of the specimen casting against a grinding/polishing wheel. Successively smaller grit sizes may be applied until a flat window is formed in the specimen casting that has a suitable size and is polished to the clarity required for specimen examination.

The window formation process may be done either manually or by automated equipment or some combination of automated equipment and manual operations. Cutting and polishing the flat window requires the necessary equipment and also generally requires about 20-30 minutes of technician time, consumes abrasive materials, and wastes the specimen casting material that is abraded away. If large numbers of specimens are mounted in specimen castings, the investment in equipment and expenditures for technician time and consumables can be significant.

Accordingly, a need exists for apparatus and methods which may reduce the time and cost of forming windows in specimen castings for analysis.

### SUMMARY OF THE INVENTION

The present invention may meet one or more of the above-mentioned needs and may provide additional advantages and improvements that will be recognized by those skilled in the art upon review of the present disclosure.

A specimen mold apparatus according to the present inventions may include a body with an interior and an exterior and corresponding inner surface and outer surface. The body has a first end and a second end. The inner surface of the body defines a passage extending from the first end to the second end of the body. The first end of the body defines a first opening contiguous with the passage and the second end of the body defines a second opening contiguous with the passage. A longitudinal axis is defined by the inner surface of the body and the longitudinal axis extends between at least the first end and the second end. The specimen mold apparatus may also include a plug with an upper surface and a lower surface. The plug is removably and sealably secured to the body such that at least portions of the upper surface of the plug and at least portions of the inner surface of the body define a cavity capable of containing a liquid received through the second opening. A spacer having a substantially flat molding face may also be included in the specimen mold apparatus. The spacer may be placed in the interior of the body to define a substantially flat surface within the passage. The flat surface may extend generally parallel to the longitudinal axis of the passage.

The body may be configured as a cylinder thereby defining a cylindrical passage between the first end and the second end. The spacer may then have a curved face that conforms to the curvature of the inner surface of the body so that the curved face of the spacer may be biased against the inner surface and the molding face of the spacer oriented toward the longitudinal axis of the body.

A specimen casting that is cast in the specimen mold apparatus may then have a flat window defined by the flat surface of the spacer through which a specimen may be observed.

The present inventions also provide methods for creating a specimen casting having a flat window through which the specimen may be observed. The methods may include providing a body with an inner surface and an outer surface, the inner surface defining a passage, and providing a plug, the plug configured to be attached to the body to define a cavity. The methods may also include placing a spacer within the passage, the spacer having a molding face, the molding face of the spacer defining a substantially flat surface within the cavity. The methods may continue by placing a specimen within the cavity, pouring casing material into the cavity, allowing the casting material to set, and removing the specimen casting from the cavity. The methods may then conclude by producing a resulting specimen casting having a substantially flat window through which the specimen may be observed.

Other features and advantages of the invention will become apparent from the following detailed description, and from the claims.

### BRIEF DESCRIPTION OF THE DRAWINGS

FIG. 1A illustrates in a perspective view an exemplary embodiment of a specimen mold apparatus according to the present invention including the body, the plug, and the spacer;

FIG. 1B illustrates in a perspective view an exemplary embodiment of a specimen casting with a substantially flat window as produced by an exemplary embodiment of a specimen mold apparatus according to the present invention;

FIG. 2 illustrates in an exploded perspective view an exemplary embodiment of a specimen mold apparatus according to the present invention including the spacer, the body, and the plug;

FIG. 3A illustrates a top view of an exemplary embodiment of a specimen mold apparatus according to the present invention including the spacer, the body, and the plug;

FIG. 3B illustrates a cut-away frontal view of an exemplary embodiment of a specimen mold apparatus according to the present invention including the spacer, the body, and the plug;

FIG. 4 illustrates a cut-away frontal view of an exemplary embodiment of a specimen mold apparatus according to the present invention including the spacer, the body, and the plug;

FIG. 5 illustrates a cut-away frontal view of an exemplary embodiment of a specimen mold apparatus according to the present invention including the spacer, the body, and the plug;

FIG. 6A illustrates an aspect of an exemplary embodiment of an apparatus according to the present invention including a top view of an embodiment of the spacer;

FIG. 6B illustrates an aspect of an exemplary embodiment of an apparatus according to the present invention including a front view of an embodiment of the spacer;

FIG. 7 illustrates a cut-away front view of an exemplary embodiment according to the present invention of the spacer and the plug with the spacer attached to the plug;

FIG. 8A illustrates a cut-away front view of an exemplary embodiment of a plug according to the present invention in which a specimen mount is attached to the plug;

FIG. 8B illustrates a cut-away front view of an exemplary embodiment of a plug according to the present invention in which the top of the plug includes an adhesive that may be used to attach a specimen to the upper surface of the plug;

FIG. 9A illustrates in a top view an exemplary embodiment of an apparatus according to the present invention including a cylindrical shaped body with a spacer mounted to the inner surface and a plug configured as a block;

FIG. 9B illustrates in a front cut-away view an exemplary embodiment of an apparatus according to the present invention including a cylindrical shaped body with a spacer mounted to the inner surface and a plug configured as a block;

FIG. 10A illustrates in a top view an exemplary embodiment of an apparatus according to the present invention including a cylindrical shaped body with a spacer mounted to the inner surface and a plug configured as a block;

FIG. 10B illustrates in a front view an exemplary embodiment of an apparatus according to the present invention including a cylindrical shaped body that includes breakpoints and a plug configured as a block;

FIG. 11A illustrates in a top view an exemplary embodiment of an apparatus according to the present invention including a flared body with a spacer mounted to the inner surface; and,

FIG. 11B illustrates in a cut-away front view an exemplary embodiment of an apparatus according to the present invention including a flared body with a spacer mounted to the inner surface.

All Figures are illustrated for ease of explanation of the basic teachings of the present invention only; the extensions of the Figures with respect to number, position, relationship and dimensions of the parts to form the embodiment will be explained or will be within the skill of the art after the following description has been read and understood. Further, the exact dimensions and dimensional proportions to conform to specific force, weight, strength, flow and similar requirements will likewise be within the skill of the art after the following description has been read and understood.

Where used in various Figures of the drawings, the same numerals designate the same or similar parts. Furthermore, when the terms “upper surface,” “lower surface,” “right,” “left,” “forward,” “rear,” “first,” “second,” “inside,” “outside,” and similar terms are used, the terms should be understood to reference only the structure shown in the drawings and utilized only to facilitate describing the illustrated embodiments.

### DETAILED DESCRIPTION OF THE INVENTION

The Figures generally illustrate embodiments of the specimen mold apparatus 20 including aspects of the present inventions. The particular exemplary embodiments of the specimen mold apparatus 20 illustrated in the Figures have been chosen for ease of explanation and understanding of various aspects of the present inventions. These illustrated embodiments are not meant to limit the scope of coverage but, instead, to assist in understanding the context of the language used in this specification and the appended claims. Accordingly, variations of the present inventions that differ from the illustrated embodiments may be encompassed by the appended claims.

The present inventions provide specimen mold apparatus 20 and associated methods for encasing a specimen 92 within a specimen casting 120 having a substantially flat window 124. As illustrated generally throughout the Figures, the specimen mold apparatus 20 according to the present inventions may include a body 30, a plug 70, and a spacer 100.

The body 30, the plug 70, and the spacer 100 may be composed of plastic, metal, paper, cardboard, or other suitable material or combinations of these and other suitable materials recognizable to one skilled in the art upon review of this disclosure.

The body 30 may be an open body with an interior 38 and an exterior 36 and a first end 32 and a second end 34. The body 30 has an inner surface 48 and an outer surface 46. The inner surface 48 of the body 30 defines a passage 40 that extends from the first end 32 to the second end 34. The first end 32 of the body 30 defines a first opening 42 contiguous with the passage 40, and the second end 34 of the body 30 defines a second opening 44 contiguous with the passage 40.

The plug 70 may have an upper surface 72 and a lower surface 74. The plug 70 may be removably and sealably secured to the body 30 to occlude the first opening 42. When the plug 70 is removably and sealably secured to the body 30, at least portions of the upper surface 72 of the plug 70 in combination with at least portions of the inner surface 48 of the body 30 define a cavity 80 capable of containing a liquid. A specimen 92 may be placed within the cavity 80 and liquid casting material 128 poured into the cavity 80 through the second opening 44. The casting material 128 may then be allowed to set to form a specimen casting 120. The specimen casting 120 may then be removed from the specimen mold apparatus 20.

In combination with the inner surface 48 of the body 30 and the upper surface 72 of the plug 70, the molding face 104 of spacer 100 defines the shape of the specimen casting 120. The spacer 100 includes a molding face 104 that alters the shape of the passage 40 defined by the body 30 by defining a substantially flat surface 114 in the passage 40. This flat surface 114 within the passage 40 defined by molding face 104 of the spacer 100 then forms a substantially flat window 124 in the specimen casting 120. The flat window 124 may be sufficiently flat such that only minimal polishing and grinding is required prior to examination or testing of the encased specimen 92.

The spacer 100, for example, may have a curved face 108 that conforms to the curvature of the inner surface 48 of the body 30 and is substantially biased against the inner surface 48 of the body 30. The spacer 100 may have a molding face 104 generally oriented toward the longitudinal axis 50 of the body 30 when the curved face 108 is biased against the inner surface 48 of the body 30. The molding face 104 of the spacer 100 may extend an entire length 41 of the body 30 or the molding face 104 of the space may extend only a portion of the length 41 of the body 30, so that the flat window 124 is formed in corresponding portions of the specimen casting 120. The molding face 104 of the spacer 100 is typically square or rectangular. However, other shapes of the molding face 104 such as a triangular shape are also contemplated. Thus, the spacer 100 provides a substantially flat surface 114 within the passage 40 that is molded into the specimen casting 120, while the outer surface 46 of the body 30 may be maintained as a cylindrical or other convenient shape.

The spacer 100 is securely biased against the inner surface 48 of the body 30. For example, in some embodiments of the specimen mold apparatus 20, the spacer 100 may be secured permanently to the body 30 of the specimen mold 20 by being affixed by glue, fusing of materials of the body 30 and the spacer 100, or otherwise permanently affixed to the body 30. In other embodiments of the specimen mold apparatus 20, the spacer 100 and body 30 may be formed as a single substantially unitary piece out of a single substantially unitary piece of material. In various other embodiments the spacer 100 may be attached removably to the inner surface of the specimen mold. In some embodiments, the spacer 100 may be free-standing within the specimen mold and positioned by placing the free-standing spacer 100 on the upper surface 72 of the plug 70 when the plug 70 is removably and sealably secured to the body 30. Such a free standing spacer 100 would be secured to the body 30 by its own weight. In still other embodiments, the spacer 100 may be affixed to the upper surface 72 of the plug 70 so that the spacer 100 is securely biased against the inner surface 48 of the body 30 when the plug 70 is removably and sealably secured to the body 30.

Various geometric features of the body 30 such as a length 41 and a cross-section 52 may be defined by the body 30. A longitudinal axis 50 may be defined by the inner surface 48 of the body 30 and the longitudinal axis 50 may pass at least through the passage 40 between the first opening 42 and the second opening 44. Then, the length 41 may be defined as the distance measured along the longitudinal axis 50 between the first opening 42 and the second opening 44. The cross-section 52 of the body 30 may be defined in a plane passing through the body 30 normal to the longitudinal axis 50. Then, the shape of the passage 40 may be defined by the integration of the shape of the cross-section 52 along the longitudinal axis 50, and the shape of at least part of the passage 40 including the flat shape of a spacer 100 having a molding face 104 would be conferred to the specimen casting 120.

The cross-section 52 of the body 30 may be substantially constant along the longitudinal axis 50, or the cross-section 52 of the body 30 may increase along the longitudinal axis 50 from the first end 32 to the second end 34 such that the cross-section 52 of the body 30 is flared toward the second end 34. Flaring means that the radius 140 of the passage 40 increases from the first end 32 to the second end 34 so that the radius 140 of the passage 40 at second end 34 is greater than radius 140 of the passage 40 at first end 32. Flaring the cross-section 52 of the body 30 facilitates removal of the specimen casting 120 by facilitating pushing the specimen casting 120 out of the flared second end 34 of the body 30.

The shape of the plug 70 may conform to the cross-sectional shape of the body 30 of the specimen mold apparatus, and the plug 70 may be configured to mechanically attach to the body 30 in a removable and sealable manner to occlude the first opening 42 of the body 30 to form the cavity 80. For example, the plug 70 may be configured to be received, at least in part, within the interior 38 of the body 30 so that the plug 70 and the body 30 are mechanically attached together by friction. In other embodiments, the plug 70 may be configured to receive portions of the outer surface 46 of the body 30 with the body 30 mechanically attached to the plug 70 by friction.

The plug 70 may include a detent 76 for mechanical attachment to the body 30, or the body 30 may include a detent 76 for mechanical attachment to the plug 70. The detent 76 may be, for example, a lip, a ridge, a flange, a series of ridges, or a groove or series of grooves. The detent 76 on the plug 70 may match a corresponding detent 76 on the body 30 and visa versa. For example, a detent 76 configured as lip on the plug 70 may be configured to mate with a lip on the body 30 so that the plug 70 may be mechanically attached to and detached from the body 30. The plug 70 and the body 30 may be mechanically attached together by a combination of friction and detent 76 or combination of detents 76. Other detents 76 and other manners of mechanical attachment may also be employed as would be readily recognized by those skilled in the art based upon this disclosure.

In some embodiments, the body 30 may rest upon portions of the upper surface 72 of the plug 70 so that the body 30 is held to the plug 70 by gravity thereby forming the cavity 80, the cavity 80 being sufficiently sealed to retain the liquid casting material 128. For example, the plug 70 may be configured as a block 132 made of metal or other such material that absorbs and dissipates heat. In such embodiments the body 30 may rest upon the upper surface 72 of the plug 70 so that the body 30 is held to the upper surface 72 of the plug 70 by gravity. The specimen 92 may be placed inside the cavity 80 and casting material 128 poured into the cavity 80. Heat produced by the setting of the casting material 128 may then be absorbed by the plug 70 and conducted away, which reduces the temperature and prevents damage to the specimen 92 caused by excessive temperatures.

These and other mechanisms recognizable to those skilled in the art based upon the present disclosure may be utilized to allow the plug 70 to be removably and sealably attached to the body 30 to occlude the first opening 42 and define the cavity 80. Alternatively, in some embodiments, the plug 70 and body 30 may be of unitary construction wherein the plug 70 and body 30 are formed from the same piece of material or the plug 70 is otherwise permanently affixed to the body 30.

In some embodiments, at least portions of the inner surface 48 of the body 30 and at least portions of the upper surface 72 of the plug 70 may be coated with mold release powder in order to facilitate the release of the specimen casting 120 from the specimen mold apparatus 20. Portions of the spacer 100 may also be coated with mold release powder.

In various embodiments of a specimen mold apparatus 20 according to the present invention, at least portions of the body 30 may be designed to break apart in order to facilitate removal of a specimen casting 120 from the body 30. Breakpoints 136 may be configured into the body 30. Breakpoints 136 may be defined as areas of reduced thickness, perforations, and similar that facilitate fracturing by creating structural weaknesses. The body 30 may then be broken about the breakpoints 136 and at least partially peeled away from the specimen casting 120. Breakpoints 136 may be arranged to form lines that may extend generally parallel to the longitudinal axis 50 and/or circumferentially around the body 30. The breakpoints 136 may also be scattered about the body 30 or otherwise organized to facilitate breakage of the body 30 and removal of the specimen casting 120 from the body 30. Some embodiments of the plug 70 may also include breakpoints 136 so that the plug 70 may be removed by being fractured and pealed away.

In some embodiments, a specimen mount 96 such as a clip, one or more pins, a holder, or other such device may be attached to the upper surface 72 of the plug 70. The specimen mount 96 may be used for affixing the specimen 92 to the upper surface 72 of the plug 70 within the cavity 80. In some embodiments, the specimen mount 96 may be connected, at least in part, to the inner surface 48 of the body 30 so that the specimen 92 may be suspended within the cavity 80 when affixed to the specimen mount 96. In other embodiments, portions of the upper surface 72 of the plug 70 may be surfaced with an adhesive coating that may be used to affix the specimen 92 to the upper surface 72 of the plug 70 within the cavity 80. Other detents 76 and combinations of detents 76 may be provided to the upper surface 72 of the plug 70 for the attachment of a specimen 92 or the attachment of a specimen mount 96 as would be readily recognized by those skilled in the art.

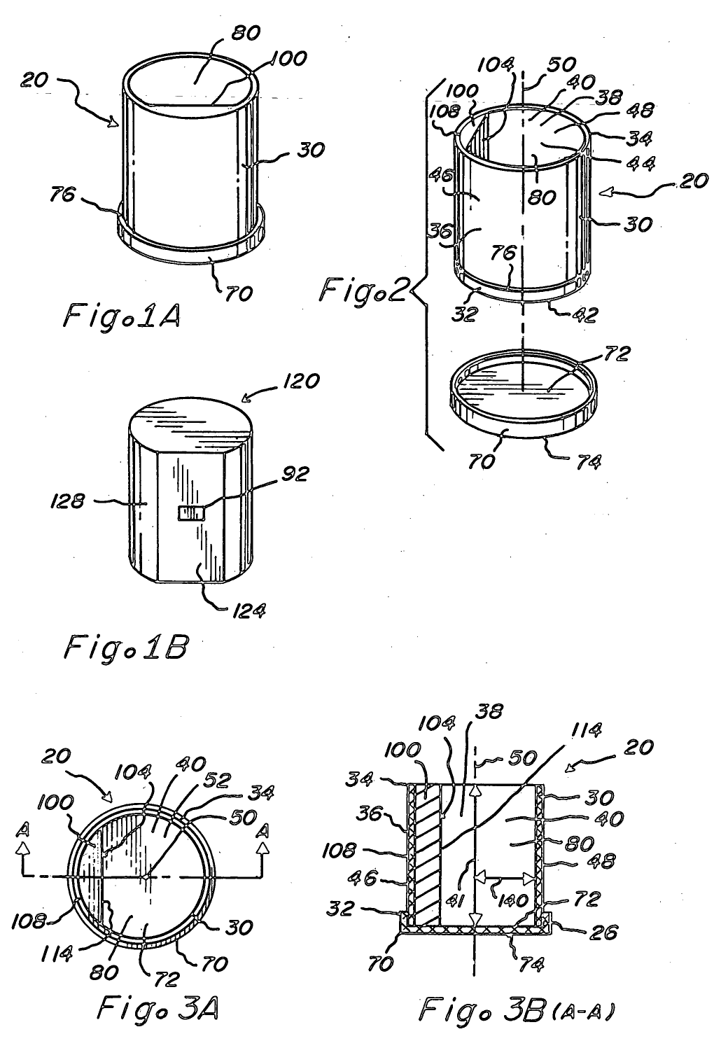

As illustrated in FIG. 1A, a specimen mold apparatus 20 in accordance with the present invention generally includes a body 30 and a plug 70. The body 30 has an inner surface 48 and an outer surface 46. The inner surface 48 defines a passage 40 through the body 30, which may be covered at the first opening 42 by the plug 70. The passage 40 may have a second opening 44 at a second end 34. The plug 70 is illustrated as attached to the body 30 at the first end 32 by a detent 76. This embodiment also illustrates a spacer 100 configured to produce a flat window 124 in a specimen casting 120 by defining a flat surface 114 in the passage 40. The spacer 100 is integral with the body, in this embodiment, by being formed from a unitary piece of material. The outer surface 46 of the body 30 maintains its cylindrical shape. The cylindrical shape of the outer surface 46 of the body 30 may be convenient for placement of the body 30 in storage racks and for other reasons.

The combination of body 30, plug 70, and spacer 100, as illustrated in FIG. 1A, defines a cavity 80 having a flat surface 114. The specimen 92 may be placed in this cavity 80 through the second opening 44. Then, liquid casting material 128 may be poured into the cavity 80 through the second opening 44 and allowed to set and cure. Upon removal from the specimen mold apparatus, the resulting casting has a flat window 124 formed by the molding face 104 of the spacer 100. The encased specimen 92 may be examined through this flat window 124. An exemplary embodiment of such a specimen casting 120 is illustrated in FIG. 1B. In this Figure, the specimen casting 120 is composed of a substantially transparent cured casting material 128 within which the specimen 92 is embedded. A flat window 124 through which the specimen 92 may be examined is molded into the side of the specimen casting 120 by the molding face 104 of the spacer 100.

FIG. 2 illustrates an exploded perspective view of an exemplary embodiment of a specimen mold apparatus 20 in accordance with the present invention. This Figure illustrates the body 30 with a spacer 100 in the interior 38 of the body 30. The body 30, in this embodiment, has a cylindrical shape and has an inner surface 48, which defines the passage 40, and an outer surface 46. The spacer 100, in this embodiment, has a curved face 108 that conforms to the curvature of the inner surface 48 of the body 30, and the curved face 108 of the spacer 100 is biased against the inner surface 48 of the body 30. The spacer 100 further includes a molding face 104 that is oriented toward the longitudinal axis 50 of the body 30 thereby defining a flat surface 114 within the passage 40. In this embodiment, the spacer 100 is permanently affixed to the body 30.

The plug 70 has an upper surface 72 and a lower surface 74. The plug 70 may be secured to the first end 32 of the body 30, in this embodiment, by detents 76 on both the plug 70 and the body 30. A portion of the upper surface 72 of the plug 70 defines the cavity 80. The cavity 80 defined by the combination of body 30, spacer 100, and plug 70 has a flat surface 114 defined by the molding face 104 of the spacer 100, so that the specimen casting 120 produced by this embodiment of the specimen mold apparatus would have a flat window 124 through which the specimen 92 may be examined.

FIGS. 3A and 3B further illustrate an embodiment of the specimen mold 20 according to the present invention in upper surface 72 and corresponding cut-away frontal views, respectively. As illustrated in these Figures, the curved face 108 of a spacer 100 is abutted against the inner surface 48 of the body 30 and the spacer 100 is affixed to the inner surface 48. The spacer 100 has a molding face 104 that defines a chord across the passage 40 defined by the body 30. A plug 70 is mated to the first end 32 of the body 30 by a detent 76 that extends over and grasps the outer surface 46 of the body 30. The plug 70, body 30, and spacer 100 define a cavity 80, the cavity 80 including a flat surface 114 defined by the molding face 104 of the spacer 100.

FIG. 4 illustrates an embodiment of the specimen mold according to the present inventions wherein the plug 70 is received within the passage 40 defined by the body 30 and frictionally held in place by a detent 76 on the plug 70 that is biased against the inner surface 48 of the body 30. Although the plug 70 is illustrated as positioned proximate the first end 32 of the body 30, it should be recognized that the plug 70 could be positioned at any location between the first end 32 and the second end 34. A spacer 100 is also included in this embodiment.

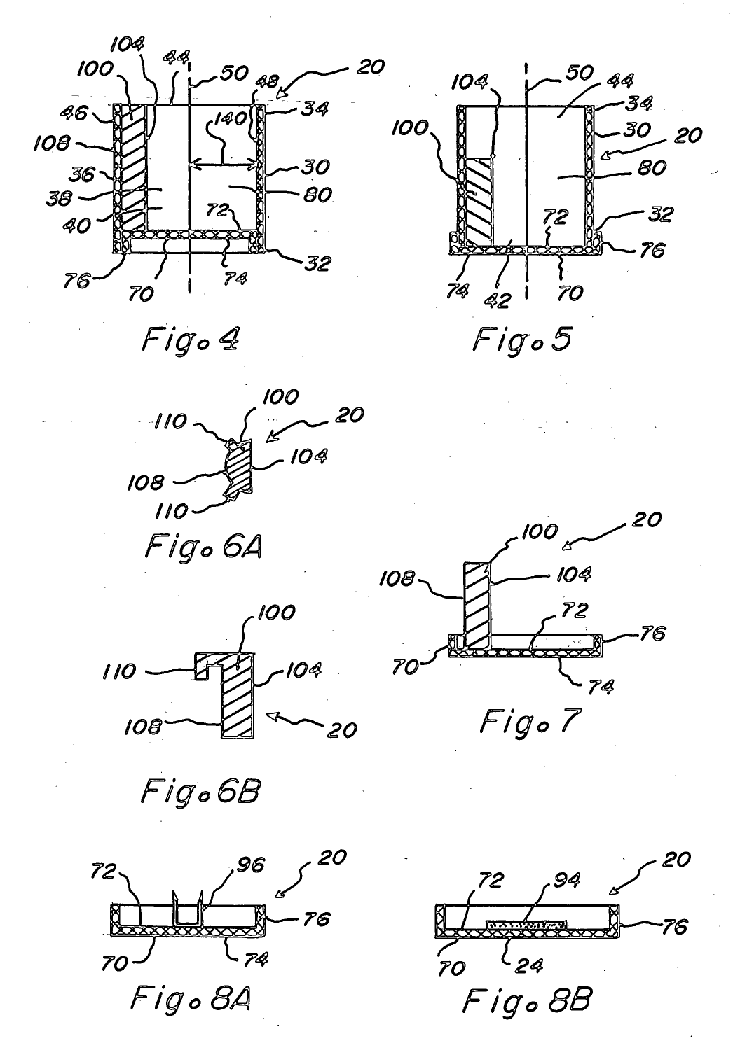

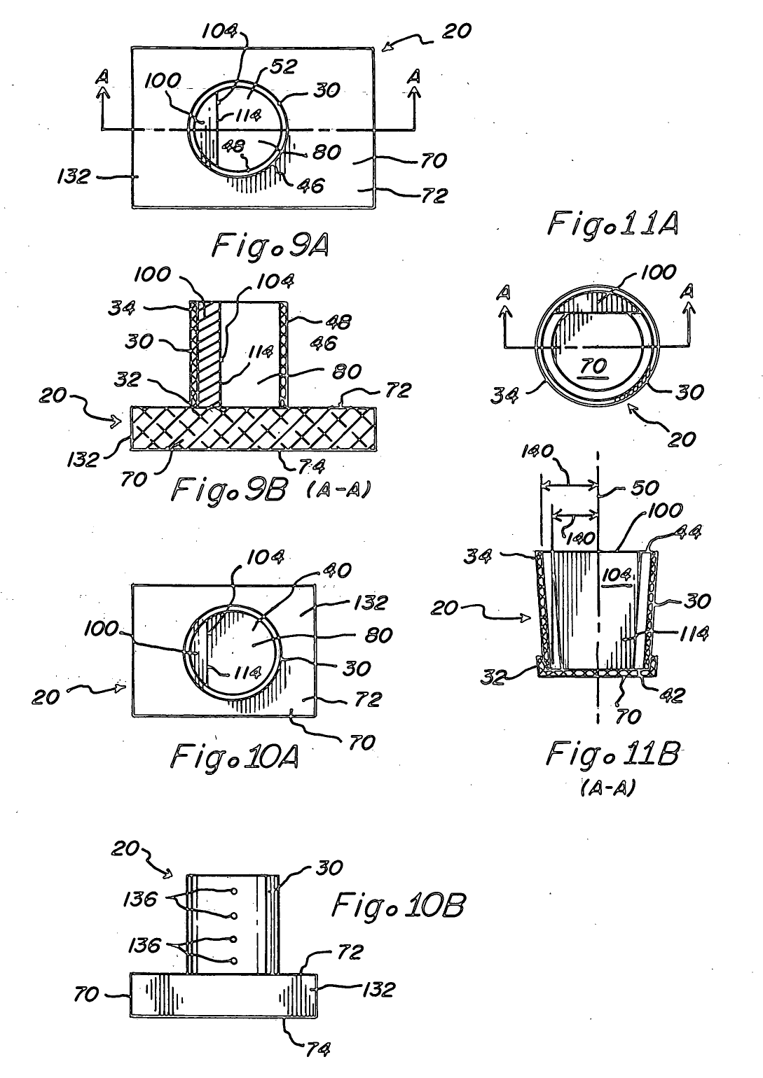

In the embodiment of FIG. 5, the spacer 100 extends from the first end 32 part-way to the second end 34. Accordingly, the spacer 100 may include two molding faces 104 that may define two flat surfaces 114 within the cavity 80.

FIGS. 6A and 6B illustrate a spacer 100 configured as a separate piece for insertion into the interior 38 of a cylindrical body 30. The spacer 100, in this embodiment, has a curved face 108 that may be biased against the inner surface 48 of the body 30 and a molding face 104 that may be oriented generally toward the longitudinal axis 50 of the cylindrical body 30. The spacer 100, in this embodiment, includes spacer detents 110. The spacer detents 110 are illustrated as hooks that attach over the second end 34 of the body 30 to bias and secure the curved face 108 of the spacer 100 against the inner surface 48 of the body 30.

In the embodiment of FIG. 7, the plug 70 is circular and the body 30 has a cylindrical shape. The spacer 100 is mounted to the plug 70 in this embodiment. The detents 76 of the plug 70, in this embodiment, may be received over the outer surface 46 of the body 30 generally at the first end 32. The spacer 100 is positioned on the plug 70 so that the spacer 100 is biased against the inner surface 48 of the body 30 to define a flat surface 114 in the cavity 80 when the plug 70 is attached to the body 30.

As illustrated in FIGS. 8A and 8B, the plug 70 may include various features for securing and orienting the specimen 92 within the cavity 80. FIG. 8A illustrates a plug 70 that includes a specimen mount 96 to which the specimen 92 may be attached. In FIG. 8B, a portion of the upper surface 72 of the plug 70 includes an adhesive to adhesively attach a specimen 92 to the plug 70.

The embodiment of the specimen mold apparatus 20 according to the present invention illustrated in FIG. 10 includes a cylindrical shaped body 30 having a spacer 100 secured to the inner surface 48 of the body 30. The spacer 100 has a molding face 104. The plug 70, in this embodiment, is configured as a block 132. The block 132 may be composed of metal or other heat conductive material. The body 30 including the spacer 100 then rests upon the upper surface 72 of the plug 70 and is held in place by gravity.

FIGS. 10A and 10B illustrate a body 30 having a cylindrical shape that further included a spacer 100 having a molding face 104 that defines a flat surface 114 within the passage 40. The body 30 in this embodiment also includes breakpoints 136. The plug 70, as illustrated, is configured as a block 132. The body 30 rests upon the upper surface 72 of the plug 70 and is secured to the upper surface 72 of the plug 70 by gravity.

A body 30 that is flared toward the second end 34 is illustrated in FIGS. 11A and 11B. The body 30 in this embodiment has a cylindrical shape and the embodiment includes a spacer 100. The body 30 is flared meaning that the radius 140 of the passage 40 increases from the first end 32 to the second end 34 so that the radius 140 of the passage 40 at second end 34 is greater than radius 140 of the passage 40 at first end 32. The spacer 100, in such an embodiment, may be configured so that the molding face 104 is generally parallel to the longitudinal axis 50, or, configured so that the molding face 104 may be generally parallel to the inner surface 48 of the body 30. Flaring of the body 30 may facilitate removal of a specimen casting 120 from the body 30. After a specimen casting 120 sets, the plug 70 may be removed and the specimen casting 120 pushed out the flared second end 34 of the body 30.

To use a specimen mold apparatus according to the present inventions, a user may begin by placing the plug 70 over the first end 32 of the body 30 or otherwise attaching the plug 70 to the body 30. In embodiments having a removable spacer 100, the spacer 100 is placed against the inner surface 48 or the spacer 100 is attached to the inner surface 48 so that the curved face 108 or faces are in alignment with and biased against the inner surface 48.

A specimen 92, which may be attached to a clip or other such mounting device, may then be placed on the plug 70 or otherwise placed within the cavity 80 of the specimen mold apparatus. Alternatively, the specimen 92 may be attached to a specimen mount 96 attached to the upper surface 72 of the plug 70 or the specimen 92 may be adhesively affixed to an upper surface 72 of a plug 70 having an adhesive coating 94. The specimen 92 is oriented such that the aspect of the specimen 92 to be examined faces the molding face 104 of the spacer 100 or other appropriate molding face 104 defined within the cavity 80. Then a casting material 128 is poured into the cavity 80 of the specimen mold apparatus 20. Epoxy, polyester, or acrylic resins may be used as the casting material 128. The casting material 128 may be substantially transparent or translucent when set. Other casting materials 128 such as liquid wax may also be used as well as other material as would be recognized by those skilled in the art. The liquid casting material 128 is then allowed to set to become solid.

After the casting material 128 sets, the body 30 may be detached from the plug 70 to reveal a portion of the specimen casting 120. The specimen casting 120 may then be removed from the body 30 by pushing on the specimen casting 120 at the first end 32 of the body 30 in the direction parallel to the longitudinal axis 50 to thereby push the specimen casting 120 out the second end 34 of the body 30. A slight flaring of the body 30 from the first end 32 to the second end 34 may facilitate pushing the specimen casting 120 out of the body 30. Inclusion of mold release powder or other readily recognized coatings on the inner surface 48 of the body 30 may also facilitate removal of the specimen casting 120 from the body 30.

In some embodiments of the specimen mold apparatus 20, the body 30 is cracked along breakpoints 136 provided in the body 30. The body 30 may then be at least partially peeled away or otherwise removed from the specimen casting 120.

After removal from the body 30, the specimen casting 120, which encases the specimen 92, contains at least one flat window 124. The flat window 124 may, at most, require only minor polishing in order to achieve the clarity required for examination of the encased specimen 92.

The foregoing discussion discloses and describes merely exemplary embodiments of the present invention. Upon review of the specification, one skilled in the art will readily recognize from such discussion, and from the accompanying drawings and claims, that various changes, modifications and variations can be made therein without departing from the spirit and scope of the invention as defined in the following claims.

What is claimed is:

1. A specimen mold, comprising:
a body comprising an inner surface and an outer surface and comprising a first end and a second end, the inner surface defining a passage extending from the first end to the second end of the body, the first end of the body defining a first opening contiguous with the passage and the second end of the body defining a second opening contiguous with the passage, the inner surface of the body defining a longitudinal axis extending between at least the first end and the second end;
a plug comprising an upper surface, the plug removably and sealably securable to the body such that at least portions of the upper surface of the plug and at least portions of the inner surface of the body define a cavity capable of containing a liquid received through the second opening; and,
a spacer comprising a molding face, the spacer secured within the cavity to form a flat surface within the passage.

2. The apparatus of claim 1, further comprising;
the body configured as a cylinder thereby defining a cylindrical passage between the first end and the second end; and,
the spacer having a curved surface, the curved surface conforming to the curvature of the inner surface of the body so that the curved face of the spacer may be securably biased against the inner surface.

3. The apparatus of claim 1, further comprising:
the body is flared.

4. The apparatus of claim 1, wherein the spacer is fixably attached to the inner surface.

5. The apparatus of claim 1, wherein the spacer is removably attached to the inner surface.

6. The apparatus of claim 1, wherein the spacer stands on the plug.

7. The apparatus of claim 1, wherein the spacer is fixably attached to the plug.

8. The apparatus of claim 1, further comprising a plurality of spacers in contact with the interior wall.

9. The apparatus of claim 1, wherein the molding face of the spacer extends part way between the first end of the body and the second end of the body.

10. The apparatus of claim 1, further comprising: the plug mechanically attached to the body.

11. The apparatus of claim 1, further comprising: the plug configured as a block and the body held to the plug by gravity.

12. The apparatus of claim 1, further comprising:
an adhesive coating on at least a portion of the upper surface of the plug.

13. The apparatus of claim 1, further comprising:
a specimen mount attached to the upper surface of the plug.

14. The apparatus of claim 1, wherein at least portions of the inner surface of the body are impregnated with mold release.

15. The apparatus of claim 1 further comprising:
the body includes at least one set of breakpoints.

16. A method for producing a specimen casting having a flat window through which the specimen may be observed, comprising:
providing a body with an inner surface and an outer surface, the inner surface defining a passage, and a plug, the plug configured to be attached to the body to define a cavity; and,
placing a spacer within the passage, the spacer having a molding face, the molding face of the spacer defining a flat surface within the cavity;

17. The method of claim 16, further comprising:
placing a specimen within the cavity;
pouring casing material into the cavity;
allowing the casting material to set; and,
removing the specimen casting from the cavity.

18. The method of claim 16, further comprising:
providing breakpoints on the body.

19. The method of claim 16, further comprising:
flaring the body from the first end toward the second end.
